(19) United States
(12) Patent Application Publication
(10) Pub. No.: US 2017/0298751 A1
(43) Pub. Date: Oct. 19, 2017

(54) MODULAR TURBINE VANE

(71) Applicant: Siemens Energy, Inc., Orlando, FL (US)

(72) Inventors: Stephen John MESSMANN, Charlotte, NC (US); Bradley J. VISSER, Longwood, FL (US)

(21) Appl. No.: 15/516,714

(22) PCT Filed: Oct. 28, 2014
(86) PCT No.: PCT/US2014/062509

§ 371 Date: Apr. 4, 2017

(51) Int. Cl. F01D 9/04; F01D 11/00

(52) U.S. Cl. CPC F01D 9/042; F01D 11/005; F01D 9/041; F05D 2230/51; F05D 2260/30; F05D 2220/32

(57) ABSTRACT

An airfoil attachment system (10) for a modular turbine vane (12) of a gas turbine engine (14) including an outer attachment system (10) with forward and aft radially extending axial hooks (20, 22) configured to be coupled directly to a vane carrier (24) to increase structural integrity of the modular vane (12) is disclosed. The airfoil attachment system (10) may also include one or more midshroud outer supports (26) positioned between the forward and aft radially extending axial hooks (20, 22) to reduce circumferential rocking movement of the airfoil vane back and forth between the suction and pressure sides (28, 30) of the vane (12). The modular turbine airfoil vane (12) may be positioned between adjacent shrouds (32, 34) forming first and second joints (88, 102). A first sealing system (104) may be placed at the first joint (88), and a second sealing system (110) may be placed at the second joint (102) to limit hot gas ingestion.

### STATEMENT REGARDING FEDERALLY SPONSORED RESEARCH OR DEVELOPMENT

Development of this invention was supported in part by the United States Department of Energy, Advanced Turbine Development Program, Contract No. DE-FC26-05NT42644. Accordingly, the United States Government may have certain rights in this invention.

### FIELD OF THE INVENTION

This invention is directed generally to turbine airfoils, and more particularly to support systems for hollow airfoils usable in a gas turbine engine and having an outer diameter support structure.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine vane and blade assemblies to these high temperatures. As a result, turbine vanes and blades must be made of materials capable of withstanding such high temperatures. In addition, turbine vanes and blades often contain cooling systems for prolonging the life of the vanes and blades and reducing the likelihood of failure as a result of excessive temperatures. Turbine engines typically include a plurality of rows of stationary turbine vanes extending radially inward from a shell and include plurality of rows of rotatable turbine blades attached to a rotor assembly for turning the rotor.

Turbine vanes are typically supported via a vane carrier. Modular turbine vanes in which the airfoils are a separate component from the shrouds typically are supported by the shrouds. In particular, the airfoil of a modular vane is typically coupled to the adjacent shrouds. The adjacent shrouds are then coupled to the vane carrier. The connection between the modular airfoil and the adjacent shrouds has proven to be a delicate and problematic joint in the field. Thus, a more robust connection system for a modular turbine vane is needed.

### SUMMARY OF THE INVENTION

An airfoil attachment system for a modular turbine vane of a gas turbine engine including an outer attachment system with forward and aft radially extending axial hooks configured to be coupled directly to a vane carrier to increase structural integrity of the modular vane is disclosed. The airfoil attachment system may also include one or more midshroud outer supports positioned between the forward and aft radially extending axial hooks to reduce circumferential rocking movement of the airfoil vane back and forth between the suction and pressure sides of the vane. The modular turbine airfoil vane may be positioned between adjacent shrouds forming first and second joints. A first sealing system may be placed at the first joint, and a second sealing system may be placed at the second joint to limit hot gas ingestion.

In at least one embodiment, the airfoil attachment system may be configured for a modular turbine vane of a gas turbine engine and may include a generally elongated hollow airfoil vane formed from an outer wall, and having a leading edge, a trailing edge, a pressure side, a suction side, and an airfoil attachment system. The airfoil attachment system may include one or more outer attachment systems at a first end of the airfoil vane. The outer attachment system may include forward and aft radially extending axial hooks, whereby the forward radially extending axial hook may be configured to be coupled directly to a vane carrier, and the aft radially extending axial hook may be configured to be coupled directly to the vane carrier. Coupling the modular turbine vane directly to the vane carrier increases the structural integrity of the connection of the modular turbine vane to the vane carrier.

The airfoil attachment system may include one or more midshroud outer supports positioned between the forward and aft radially extending axial hooks to reduce circumferential rocking movement of the airfoil vane. The midshroud outer support may include one or more midairfoil suction hooks extending radially outwardly from the airfoil vane at the suction side with one or more midairfoil vane engaging surfaces, and one or more midshroud suction hooks extending radially outwardly from a first shroud having an inner surface forming a radially outer surface of a hot gas path and a first side surface configured to mate with the suction side of the airfoil vane at a first joint, wherein the at least one midshroud suction hook may include one or more midairfoil shroud engaging surfaces. The midairfoil vane engaging surface and the midairfoil shroud engaging surface may be in mating engagement to limit circumferential rocking movement of the airfoil vane. In at least one embodiment, the midairfoil vane engaging surface and the midairfoil shroud engaging surface may be positioned generally orthogonal to an axially extending longitudinal axis of the airfoil vane. The midairfoil suction hook and the midshroud suction hook may extend from the forward radially extending axial hook to the aft radially extending axial hook.

In at least one embodiment, the midshroud outer support may include one or more midairfoil pressure hooks extending radially outwardly from the airfoil vane at the pressure side with one or more midairfoil vane engaging surfaces and one or more midshroud pressure hooks extending radially outwardly from a second shroud having an inner surface forming a radially outer surface of a hot gas path and a second side surface configured to mate with the pressure side of the airfoil vane at a second joint, wherein the midshroud pressure hook may include one or more midairfoil shroud engaging surfaces. The midairfoil vane engaging surface and the midairfoil shroud engaging surface may be in mating engagement to limit circumferential rocking movement of the airfoil vane at the pressure side of the airfoil vane.

The airfoil attachment system may also include a first shroud having an inner surface forming a radially outer surface of a hot gas path and a first side surface configured to mate with the suction side of the airfoil vane at a first joint and a second shroud having an inner surface forming a radially outer surface of the hot gas path and a second side surface configured to mate with the pressure side of the airfoil vane at a second joint. The airfoil attachment system may include a first sealing system at the first joint. The first sealing system at the first joint may be formed from at least one male female connection or other appropriate connection. The airfoil attachment system may include a second sealing system at the second joint. The second sealing system at the second joint may be formed from at least one male female connection.

During turbine engine operation, the airfoil attachment system may position the airfoil vane relative to the vane carrier and limit movement. In particular, the midshroud outer support limits the modular turbine vane from rocking back and forth while attached to the vane carrier by locking the modular turbine vane in place relative to the adjacent first and second shrouds.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a cross-sectional view of a gas turbine engine.

FIG. 2 is a side view of a modular airfoil vane attached to a vane carrier via an airfoil attachment system.

FIG. 3 is a perspective view of a modular airfoil vane attached to a vane carrier via an airfoil attachment system.

FIG. 4 is a detail, perspective view of a midshroud outer support positioned between the forward and aft radially extending axial hooks to reduce circumferential rocking movement of the airfoil vane back and forth between the suction and pressure sides of the vane.

FIG. 5 is a detail, perspective view of a midairfoil suction hook of the midshroud outer support extending from the airfoil.

FIG. 6 is a detail, perspective view of a midairfoil suction hook engaged to a midairfoil suction hook of the midshroud outer support.

FIG. 7 is a perspective view of an alternative embodiment of the midairfoil suction hook engaged to a midshroud of the midshroud outer support at a forward radially extending axial hook.

FIG. 8 is a detail, cross-sectional view of the joint between the airfoil and a first adjacent shroud.

FIG. 9 is a detail, cross-sectional view of another embodiment of the joint between the airfoil and a first adjacent shroud.

FIG. 10 is a detail, cross-sectional view of the joint between the airfoil and a second adjacent shroud.

FIG. 11 is a detail, cross-sectional view of another embodiment of the joint between the airfoil and a second adjacent shroud.

### DETAILED DESCRIPTION OF THE INVENTION

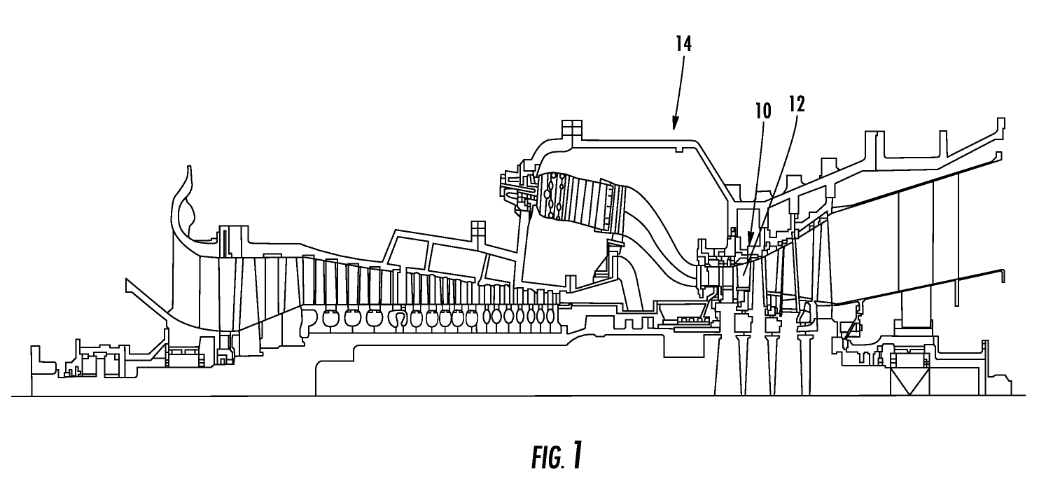

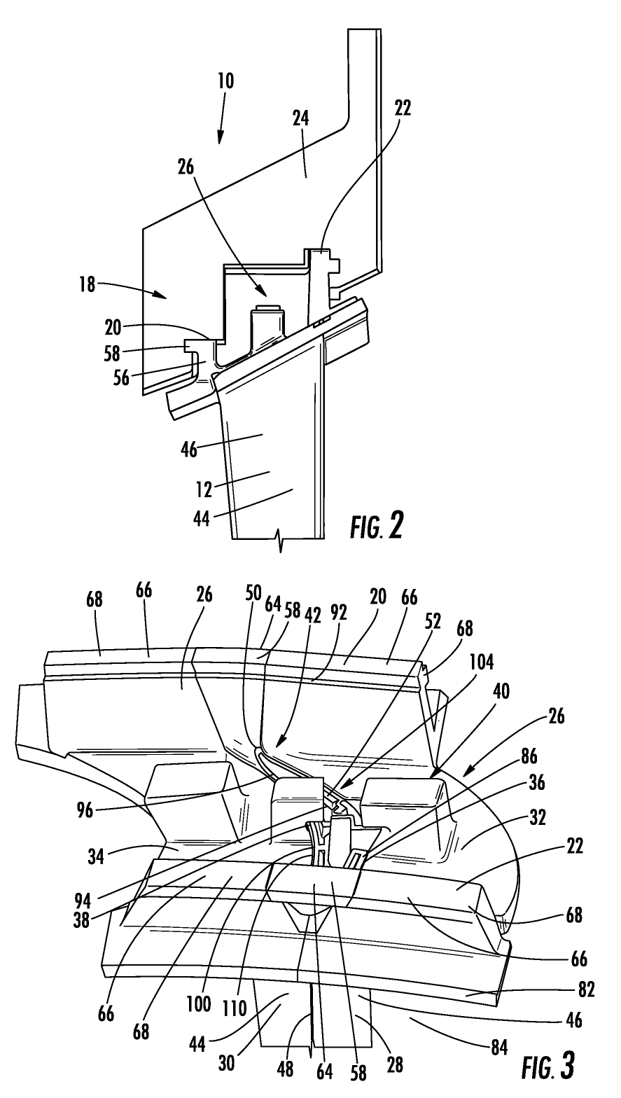

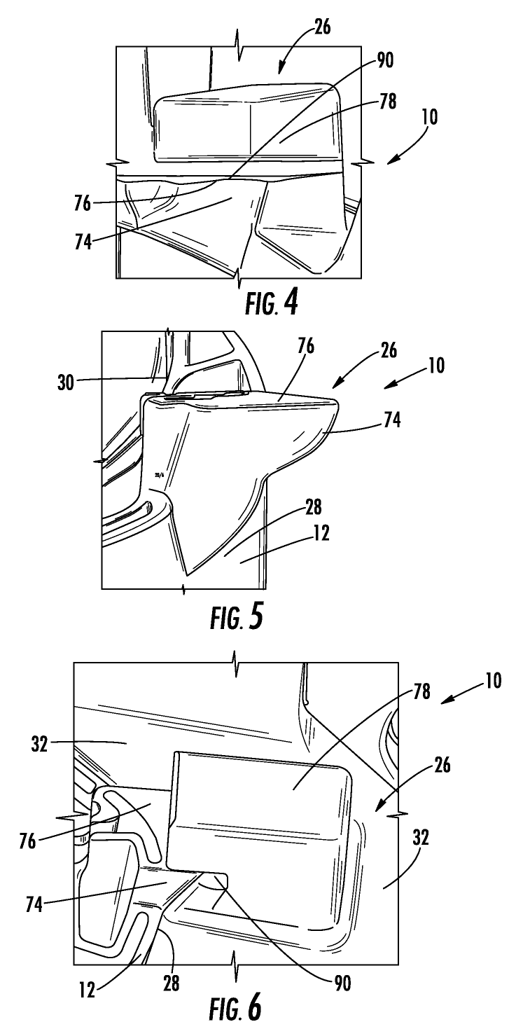

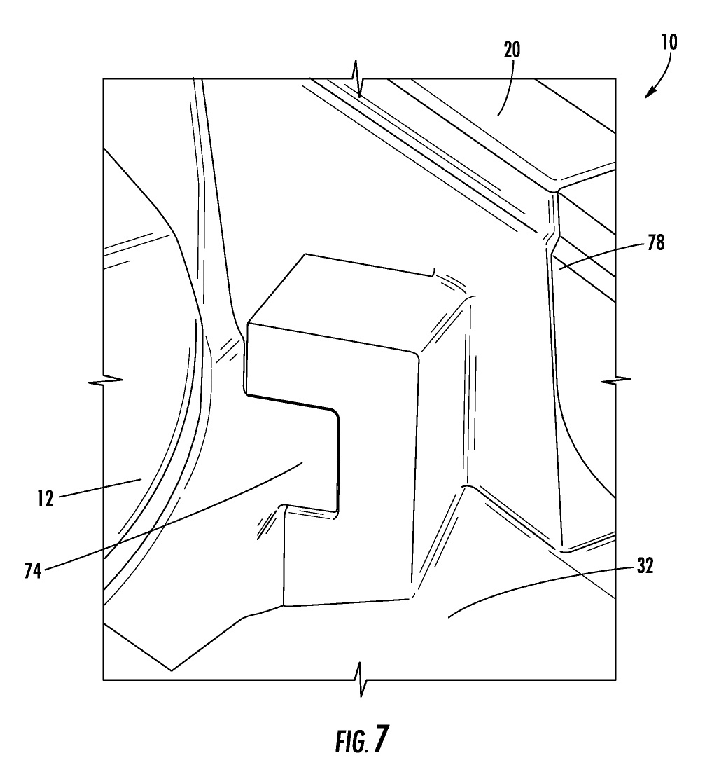

As shown in FIGS. 1-11, an airfoil attachment system 10 for a modular turbine vane 12 of a gas turbine engine 14 including outer attachment system 18 with forward and aft radially extending axial hooks 20, 22 configured to be coupled directly to a vane carrier 24 to increase structural integrity of the modular vane 12 is disclosed. The support system 10 may also include one or more midshroud outer supports 26 positioned between the forward and aft radially extending axial hooks 20, 22 to reduce circumferential rocking movement of the airfoil vane 12 back and forth between the suction and pressure sides 28, 30 of the vane 12. The modular turbine airfoil vane 12 may be positioned between adjacent shrouds 32, 34 forming first and second joints 36, 38. A first sealing system 40 may be placed at the first joint 36, and a second sealing system 42 may be placed at the second joint 38 to limit hot gas ingestion.

In at least one embodiment, the modular turbine vane 12 of a gas turbine engine 14 may include a generally elongated hollow airfoil vane 44 formed from an outer wall 46, and having a leading edge 48, a trailing edge 50, a pressure side 30, a suction side 28, and an airfoil attachment system 10. The airfoil attachment system 10 may include one or more outer attachment systems 18 at a first end 52 of the airfoil vane 44, as shown in FIG. 3. The outer attachment system 18 may include forward and aft radially extending axial hooks 20, 22, whereby the forward radially extending axial hook 20 may be configured to be coupled directly to a vane carrier 24. The aft radially extending axial hook 22 may be configured to be coupled directly to the vane carrier 24 as well.

In at least one embodiment, as shown in FIG. 3, the forward radially extending axial hook 20 may include one or more first radially outward extending first legs 56 coupled to an upstream extending arm 58. An outer surface 64 of the upstream extending arm 58 may be generally flush with outer surfaces 66 of adjacent forward hooks 68 extending outwardly from first and second shrouds 32, 34 on the pressure and suction sides 30, 28 of the airfoil vane 12. The forward radially extending axial hook 20 may be configured to be coupled directly to a vane carrier 24, and the aft radially extending axial hook 22 may be configured to be coupled directly to the vane carrier 24. The aft radially extending axial hook 22 may be configured similarly to the forward radially extending axial hook 20 except that the upstream extending arm 58 extends downstream.

The airfoil attachment system 10 may include one or more midshroud outer supports 26 positioned between the forward and aft radially extending axial hooks 20, 22 to reduce circumferential rocking movement of the airfoil vane 12. The midshroud outer support 26 may include one or more midairfoil suction hooks 74 extending radially outwardly from the airfoil vane 12 at the suction side 28 with one or more midairfoil vane engaging surfaces 76. The midshroud outer support 26 may also include one or more midshroud suction hooks 78 extending radially outwardly from a first shroud 32 having an inner surface 82 forming a radially outer surface of a hot gas path 84 and a first side surface 86 configured to mate with the suction side 28 of the airfoil vane 12 at a first joint 36, wherein the midshroud suction hook 78 may include one or more midairfoil shroud engaging surfaces 90. The midairfoil vane engaging surface 78 and the midairfoil shroud engaging surface 90 may be in mating engagement to limit circumferential rocking movement of the airfoil vane 12. In at least one embodiment, the midairfoil vane engaging surface 76 and the midairfoil shroud engaging surface 90 may be positioned generally orthogonal to an axially extending longitudinal axis 92 of the airfoil vane 12. In at least one embodiment, as shown in FIG. 3, the midairfoil suction hook 74 and the midshroud suction hook 78 may be positioned at a midpoint between the forward and aft radially extending axial hooks 20, 22. In another embodiment, the midairfoil suction hook 74 and the midshroud suction hook 78 may extend from the forward radially extending axial hook 20 to the aft radially extending axial hook 22. In yet another embodiment, as shown in FIG. 7, the midairfoil suction hook 74 and the midshroud suction hook 78 may be positioned at the forward radially extending axial hook 20 or the aft radially extending axial hook 22, or both.

The midshroud outer support 26 may include one or more midairfoil pressure hooks 94 extending radially outwardly from the airfoil vane 12 at the pressure side 30 with one or more midairfoil vane engaging surfaces 76 and one or more midshroud pressure hooks 96 extending radially outwardly from a second shroud 34 having an inner surface 82 forming a radially outer surface of a hot gas path 84 and a second side surface 100 configured to mate with the pressure side 30 of the airfoil vane 12 at a second joint 38, wherein the midshroud pressure hook 96 includes one or more midairfoil shroud engaging surfaces 90. The midairfoil vane engaging surface 76 and the midairfoil shroud engaging surface 90 of the midshroud pressure hook 94 may be in mating engagement to limit circumferential rocking movement of the airfoil vane 12.

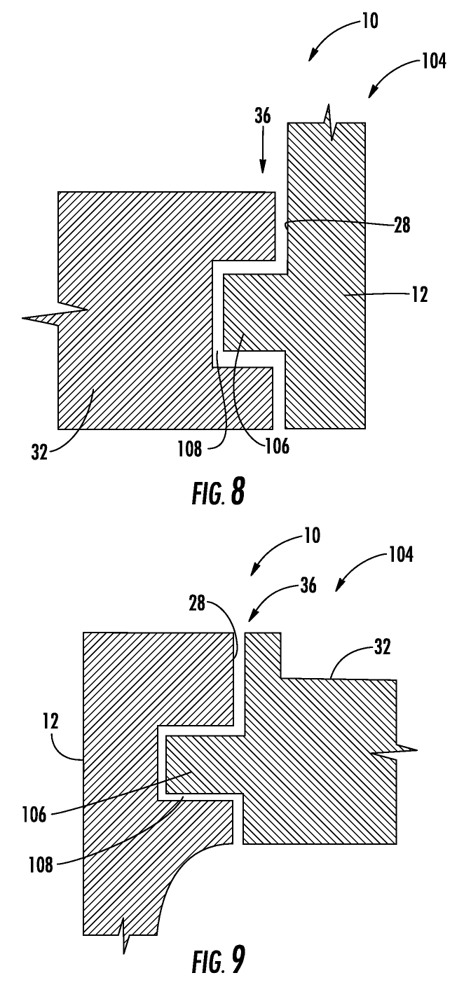

The airfoil attachment system 10 may include a first shroud 32 having an inner surface 82 forming a radially outer surface of a hot gas path 84 and a first side surface 86 configured to mate with the suction side 28 of the airfoil vane 12 at a first joint 36 and a second shroud 34 having an inner surface 82 forming a radially outer surface of the hot gas path 84 and a second side surface 100 configured to mate with the pressure side 30 of the airfoil vane 12 at a second joint 38. The airfoil attachment system 10 may also include a first sealing system 104, as shown in FIGS. 8 and 9, at the first joint 36. In at least one embodiment, the first sealing system 104 at the first joint 36 may be formed from one or more male female connections. In at least one embodiment, as shown in FIG. 9, a protrusion 106 may extend from the first shroud 32 and be received within a cavity 108 in the suction side 28 of the airfoil vane 12. In another embodiment, as shown in FIG. 8, the protrusion 106 may extend from the suction side 28 of the airfoil vane 12 and may be received within a cavity 108 in the first shroud 32. The first sealing system 104 may extend for an entire length of the first joint 36 or for only a portion of the first joint 36.

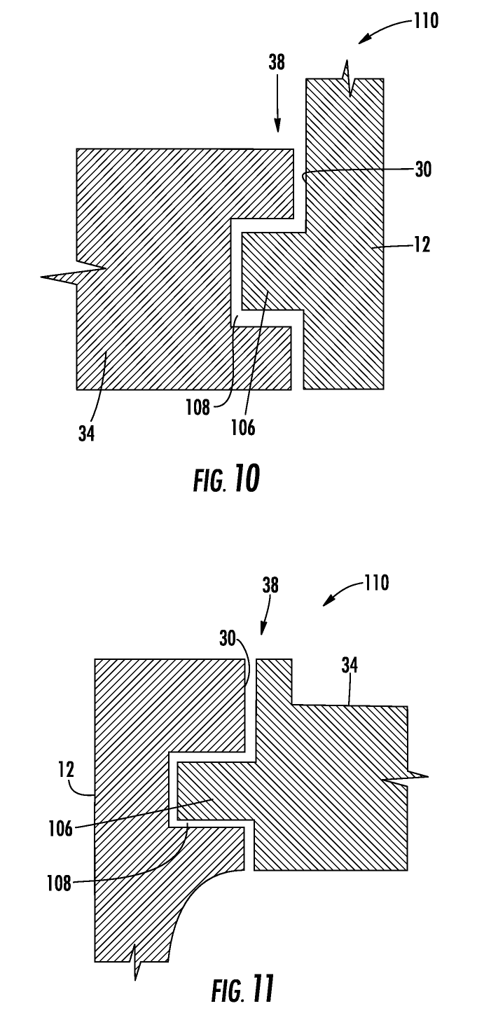

The airfoil attachment system 10 may also include a second sealing system 110 at the second joint 38. In at least one embodiment, the second sealing system 110 at the second joint 38 may be formed from one or more male female connections. In at least one embodiment, as shown in FIG. 11, a protrusion 106 may extend from the second shroud 34 and be received within a cavity 108 in the pressure side 30 of the airfoil vane 12. In another embodiment, as shown in FIG. 10, the protrusion 106 may extend from the pressure side 30 of the airfoil vane 12 and may be received within a cavity 108 in the second shroud 34. The second sealing system 110 may extend for an entire length of the second joint 38 or for only a portion of the second joint 38.

During turbine engine operation, the airfoil attachment system 10 may position the airfoil vane 12 relative to the vane carrier 24 and limit movement. In particular, the midshroud outer support limits the modular turbine vane 12 from rocking back and forth while attached to the vane carrier 24 by locking the modular turbine vane 12 in place relative to the adjacent first and second shrouds 32, 34.

The foregoing is provided for purposes of illustrating, explaining, and describing embodiments of this invention. Modifications and adaptations to these embodiments will be apparent to those skilled in the art and may be made without departing from the scope or spirit of this invention.

1. A modular turbine vane of a gas turbine engine, comprising:
a generally elongated hollow airfoil vane formed from an outer wall, and having a leading edge, a trailing edge, a pressure side, a suction side, and an airfoil attachment system;
wherein the airfoil attachment system includes at least one outer attachment system at a first end of the airfoil vane; and
wherein the outer attachment system includes forward and aft radially extending axial hooks, whereby the forward radially extending axial hook is configured to be coupled directly to a vane carrier and wherein the aft radially extending axial hook is configured to be coupled directly to the vane carrier.

2. The modular turbine vane of claim 1, wherein at least one midshroud outer support positioned between the forward and aft radially extending axial hooks to reduce circumferential rocking movement of the airfoil vane.

3. The modular turbine vane of claim 2, wherein the midshroud outer support comprises at least one midairfoil suction hook extending radially outwardly from the airfoil vane at the suction side with at least one midairfoil vane engaging surface and at least one midshroud suction hook extending radially outwardly from a first shroud having an inner surface forming a radially outer surface of a hot gas path and a first side surface configured to mate with the suction side of the airfoil vane at a first joint, wherein the at least one midshroud suction hook includes at least one midairfoil shroud engaging surface and wherein the at least one midairfoil vane engaging surface and the at least one midairfoil shroud engaging surface are in mating engagement to limit circumferential rocking movement of the airfoil vane.

4. The modular turbine vane of claim 3, wherein the at least one midairfoil vane engaging surface and the at least one midairfoil shroud engaging surface are positioned generally orthogonal to an axially extending longitudinal axis of the airfoil vane.

5. The modular turbine vane of claim 3, wherein the at least one midairfoil suction hook and the at least one midshroud suction hook extend from the forward radially extending axial hook to the aft radially extending axial hook.

6. The modular turbine vane of claim 3, wherein the midshroud outer support comprises at least one midairfoil pressure hook extending radially outwardly from the airfoil vane at the pressure side with at least one midairfoil vane engaging surface and at least one midshroud pressure hook extending radially outwardly from a second shroud having an inner surface forming a radially outer surface of a hot gas path and a second side surface configured to mate with the pressure side of the airfoil vane at a second joint, wherein the at least one midshroud pressure hook includes at least one midairfoil shroud engaging surface and wherein the at least one midairfoil vane engaging surface and the at least one midairfoil shroud engaging surface are in mating engagement to limit circumferential rocking movement of the airfoil vane.

7. The modular turbine vane of claim 1, wherein a first shroud having an inner surface forming a radially outer surface of a hot gas path and a first side surface configured to mate with the suction side of the airfoil vane at a first joint and a second shroud having an inner surface forming a radially outer surface of the hot gas path and a second side surface configured to mate with the pressure side of the airfoil vane at a second joint.

8. The modular turbine vane of claim 7, wherein a first sealing system at the first joint.

9. The modular turbine vane of claim 8, wherein the first sealing system at the first joint is formed from at least one male female connection.

10. The modular turbine vane of claim 7, wherein a second sealing system at the second joint.

11. The modular turbine vane of claim 10, wherein the second sealing system at the second joint is formed from at least one male female connection.
